(19) United States
(12) Patent Application Publication
(10) Pub. No.: US 2025/0259097 A1
(43) Pub. Date: Aug. 14, 2025

(54) Multi-Variate Artificial Intelligence (AI) Algorithm for Ubiquitous, Omni-Channel Applications

(71) Applicant: KIMBERLY JOHNSON, New Orleans, LA (US)

(72) Inventor: KIMBERLY JOHNSON, New Orleans, LA (US)

(21) Appl. No.: 18/438,433

(22) Filed: Feb. 10, 2024

(51) Int. Cl. G06N 20/00

(52) U.S. Cl. CPC G06N 20/00

(57) ABSTRACT

An Artificial Intelligence (AI) data algorithm, including: structured dataset accessible by an analyst or engineer operable for receiving data from one or more sources, applying the algorithm minimizer and optimizer to the features identified in the data, and displaying summary information to the analyst or engineer (the algorithm output); an artificial intelligence algorithm accessible by the analyst or engineer operable for applying the omnichannel Artificial Intelligence methodology to the data and triggering and executing an action on behalf of the analyst or engineer to provide data insights and observations.

### BACKGROUND

### Field of the Invention

This present invention is directed to the growing, but disjointed field of Artificial Intelligence, particularly Machine Learning algorithms and Feature Engineering.

### Description of the Related Art

Artificial Intelligence (AI), and its subcategory of Machine Learning, is evolving rapidly. Yet, related art in the field of AI in all industrial sectors is nascent in terms of standardization and disciplined implementation across segments in business and technical organizations. The current breakthroughs in AI are in computer application-related (i.e., natural language generation, speech recognition, virtual agents) and are limited in their cross functional pertinence and viability. As a result, the AI field has had a small effect on classical fields such as Engineering, which is based on physical science and the scientific thought framework process.

### SUMMARY

In one embodiment of the present invention, the complexity of AI and Machine Learning algorithms are significantly simplified and collapsed for consumption through feature reduction.

This algorithm can be used across disciplines and industry segments, and therefore, can be represented for ubiquitous, omni-channel applications.

### BRIEF DESCRIPTION OF THE DRAWINGS

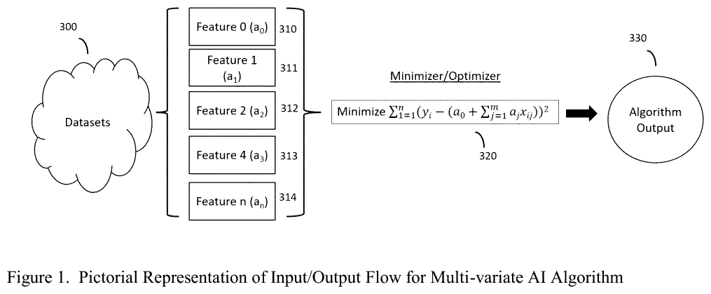

FIG. 1. Pictorial Representation of Input/Output Flow for Multi-variate AI Algorithm
Datasets (301) are structured and are numerical.
Input of datasets are labeled for features (310, 311, 312, 313, 314), which represent variables.
Features are minimized and optimized (320) for faster and more efficient processing.
Algorithm output (330) is a reduced representation of complex datasets.

### DETAILED DESCRIPTION

A Multi-Variate Artificial Intelligence (AI) Algorithm (320) presents ubiquitous, omni-channel presents numerical solutions for applications in classical sciences and technical operations. This invention, the process of defining, reducing, and optimizing the algorithm is novel and innovative. This algorithm and its process provides insights into operations and classical engineering processes.

An Artificial Intelligence (AI) data algorithm (320), including: structured dataset (300) accessible by an analyst or engineer operable for receiving data from one or more sources, applying the algorithm minimizer (320) to the features (311, 312, 313, 314) identified in the data, and displaying summary information (330) to the analyst or engineer (the algorithm output); an artificial intelligence algorithm accessible by the analyst or engineer operable for applying the omnichannel Artificial Intelligence methodology to the data and triggering and executing an action on behalf of the analyst or engineer to provide data insights and observations (330).

1. This invention, the Multi-Variate Artificial Intelligence (AI) Algorithm, through feature reduction, significantly simplifies and collapses AI problems for consumption for ubiquitous, omni-channel applications across industries and disciplines.
